(19) United States
(12) Patent Application Publication
(10) Pub. No.: US 2026/0175941 A1
(43) Pub. Date: Jun. 25, 2026

(54) Method for Operating a Drive Assembly of an Electric Bicycle

(71) Applicant: Robert Bosch GmbH, Stuttgart (DE)

(72) Inventors: Joseph Reck, Weil Im Schoenbuch (DE); Sebastian Eberle, Tuebingen (DE)

(21) Appl. No.: 19/427,587

(22) Filed: Dec. 19, 2025

(30) Foreign Application Priority Data
Dec. 23, 2024 (DE) 10 2024 212 269.6

(51) Int. Cl. B62M 6/50; B62M 25/08

(52) U.S. Cl. CPC B62M 6/50; B62M 25/08

(57) ABSTRACT

A method for operating a drive assembly of an electric bicycle includes (i) detecting a pedaling frequency of a crank mechanism, (ii) detecting a rear wheel speed of a rear wheel, (iii) determining a transmission ratio between the crank mechanism and the rear wheel, (iv) determining an engagement ratio based on the pedaling frequency and rear wheel speed and the transmission ratio, and (v) generating the motor torque as a function of the determined engagement ratio.

This application claims priority under 35 U.S.C. § 119 to patent application no. DE 10 2024 212 269.6, filed on Dec. 23, 2024 in Germany, the disclosure of which is incorporated herein by reference in its entirety.

### BACKGROUND

The present disclosure relates to a method for operating a drive assembly of an electric bicycle, a drive assembly of an electric bicycle, as well as to an electric bicycle.

Electric bicycles are known with a drive assembly for generating a motor torque to provide motor assistance to the manual pedaling force of a rider. The generation of the motor torque is typically dependent on the pedaling force of the rider. Often, a pedaling torque generated by the rider is directly detected, for example, by way of torque sensors. However, this often requires a complex and costly design of the drive assembly of the electric bicycle.

### SUMMARY

In contrast, the method according to the disclosure having the features of set forth below is characterized by the fact that motor assistance of an electric bicycle can be provided in a particularly simple and cost-effective manner. In particular, a particularly simple and cost-effective design of the drive assembly of the electric bicycle is enabled. This is achieved according to the disclosure by a method for operating a drive assembly of an electric bicycle, comprising the steps of:
detecting a pedaling frequency of a crank mechanism,
detecting a rear wheel speed of a rear wheel,
determining a transmission ratio between the crank mechanism and the rear wheel,
determining an engagement ratio based on pedaling frequency and rear wheel speed and transmission ratio, and
generating the motor torque as a function of the determined engagement ratio.

A transmission ratio of a mechanical torque transfer path between the crank mechanism and the rear wheel is in particular considered to be a transmission ratio. For example, in the case of a direct torque transfer connection, i.e., in particular with complete engagement or force closure of the torque transfer path, the transmission ratio corresponds to ratio of the pedaling frequency to the rear wheel speed.

The engagement ratio is particularly considered to be a predetermined factor determined solely based on the magnitudes of pedaling frequency, rear wheel speed, and transmission ratio. Preferably, the engagement ratio corresponds to a ratio of the detected rear wheel speed to the pedaling frequency multiplied by the transmission ratio. Particularly preferably, the engagement ratio k is determined based on the formula:

$$k = \frac{{ω}_{h r}}{i \cdot {ω}_{k}}$$

where i denotes the transmission ratio, ωₕᵣ, denotes the rear wheel speed, and ωₖ denotes the pedaling frequency.

Preferably, the motor torque is generated as a function of the determined engagement ratios such that a higher motor torque is generated at higher engagement ratios and a lower motor torque is generated at lower engagement ratios.

In other words, the method simultaneously detects a pedaling frequency and a rear wheel speed, preferably while the electric cycle is moving forward. Also, an instantaneous transmission ratio between the crank mechanism and rear wheel is simultaneously detected. Based on these determined magnitudes, an instantaneous engagement ratio of the drive train of the electric bicycle is determined. The generation of the motor torque, in particular by way of a drive unit of the drive assembly of the electric bicycle, is carried out as a function of the determined engagement ratio.

The method thus offers the advantage that the motor torque can be controlled reliably in a particularly simple and cost-efficient manner and based on a particularly simple detection option. Simple and cost-efficient sensors can be used, such as speed sensors. In particular, a torque sensor may be omitted. In addition, the calculation of the motor torque to be achieved may be performed in a particularly straightforward and time-efficient manner. Furthermore, by considering the actual instantaneous state of the drive train with respect to pedal actuation, an optimal control of the drive adapted to the pedaling behavior of the rider may be provided. For example, a particularly high level of riding comfort for the rider of the electric bike can thereby be enabled.

Preferred exemplary embodiments of the disclosure are set forth below.

Preferably, the method further comprises the following step: detecting an active rider engagement when the determined engagement ratio corresponds to at least one predetermined engagement threshold. The motor torque is thereby generated as a function of the detected active rider engagement. In particular, active rider engagement is considered to be an interaction between the rider of the electric bicycle and the drive train of the electric bicycle that generates propulsive torque. That is to say, with active rider engagement, the force applied by the rider's pedaling generates at least a proportion of the drive torque of the electric bicycle. In other words, with active rider engagement, the drive train is tensioned by the pedaling force of the rider. Particularly preferably, the engagement threshold value is at least 0.85, preferably at least 0.9, further preferably at least 0.95, in particular a maximum of 1.1. Preferably, the controlled generation of the motor torque occurs as a function of the active rider engagement such that a specific targeted motor torque is provided exclusively when active rider engagement is detected. That is, a desired target motor torque, which is pre-determined, for example, by way of various assistance modes of the electric bicycle, is only provided while the active rider engagement is detected. Thus, simply and cost-effectively, a particularly targeted operation of the electric bicycle can be provided with a high level of user comfort.

Particularly preferably, a characteristic line is defined which defines a target motor assistance as a function of the engagement ratio. The generation of the motor torque is based on the characteristic curve. That is to say, in particular, the characteristic curve defines exactly one value for the target motor assistance for each possible engagement ratio, which is used in particular to regulate the motor torque during controlled generation. Preferably, the characteristic curve is precisely predefined and, for example, stored. Alternatively preferably, the characteristic curve is configured to be adaptable, for example, based on different travel parameters or the like. By way of the characteristic curve, operation of the electric cycle can be carried out in a particularly straightforward manner and simply and cost-effectively, wherein an optimum provision of the motor torque can be enabled for a high level of riding comfort.

Preferably, the characteristic defines an engagement area within which an engagement ratio has the value 1. In particular, the engagement area corresponds to a portion of the characteristic curve that extends over a specific engagement ratio area. In particular, the value 1 is centrally within this engagement ratio area. The engagement area here defines a predetermined engagement motor assistance as the target motor assistance. Preferably, engagement motor assistance is considered as the output torque of a ride controller, or alternatively a predetermined defined motor torque with a specific value, or alternatively a factor of 1 multiplied by the output torque of the ride controller. Preferably, the engagement area extends between engagement ratios of at least 0.85, preferably at least 0.9, in particular at least 0.95, to a maximum of 1.2, preferably at a maximum of 1.15, in particular at a maximum of 1.1, particularly preferably at a maximum of 1.05. In other words, the characteristic curve defines, by way of the engagement area, which substantially represents the detected active rider engagement, that the full intended motor torque is provided. For example, this motor torque may be generated based on the output of the drive controller, which may in particular provide a specific motor torque as a function of a selected assistance mode. This makes it possible to generate the intended motor torque in a particularly targeted and simple manner with active rider engagement.

Further preferably, the characteristic curve comprises a boost area, which has engagement ratios of greater than 1, in particular greater than or equal to 1.05. The boost area here defines a boost motor assistance as the target motor assistance, which is greater than the engagement motor assistance. In particular, the boost motor assistance corresponds to a maximum motor assistance that the drive assembly can provide. That is, in the boost area, the maximum possible motor torque of the power unit of the drive assembly is generated as the motor torque.

Preferably, the boost area comprises at least one linear area and a constant area, wherein the linear area is arranged between the constant area and the engagement area of the characteristic curve. In the linear range, there is a linear increase in the motor assistance as a function of the engagement ratio, in particular up to the boost motor assistance of the constant range. Thus, a continuous increase in motor torque may be provided at higher engagement ratios than in the engagement area.

In particular, by way of the boost area, a short-term increase in the maximum assistance of the drive arrangement may be provided. Thus, for example, acceleration operations with short-term, particularly high acceleration, can be enabled. For example, excessive engagement ratios may occur that are higher than those from active rider engagement in instances where, for example, high or sharp increasing rider pedal torque causes stretching and elongations in portions of the drive train. That is to say, for example, that if the rider pedals very hard, the bicycle chain is stretched, which can cause the determined gear ratio to rise above the value of 1 or 1.05. Alternatively, the increased engagement ratio may occur through faster, more accurate detection of the signals on the crank compared to the rear wheel. By providing the maximum possible motor torque in these situations, a particularly high level of riding comfort can be provided to the rider by a high level of assistance in these situations.

Preferably, the characteristic curve further defines a neutral area which is at engagement ratios of less than 0.8, particularly less than 0.5. The neutral area defines a target motor assistance of zero. In particular, an area in which the rider of the electric bicycle does not pedal or pedals without resistance, i.e., with a pedaling frequency that is significantly below an engagement pedaling frequency, is considered to be the neutral area. In the neutral area, no motor torque is generated by the power unit. Thus, it can be easily and reliably ensured that no motor torque is generated when pedaling without load or when the pedals are not operated at all.

Further preferably, the characteristic curve further defines a ramp area that lies between the neutral area and the engagement area. The ramp area defines a continuous increase in the target motor assistance as a function of the determined engagement ratio. That is, with engagement ratios that are within the ramp area, there is a low level of motor assistance with a motor torque below the predetermined engagement motor assistance of the engagement range. This enables continuous, progressive activation of motor assistance from zero to the engagement motor assistance. This means that the motor assistance does not take place in abruptly, but rather gently engages when the rider is about to take full active control. Similarly, when the active rider intervention is about to end, i.e. when the engagement ratio decreases, the motor assistance is slowly and continuously reduced to zero. Thus, a particularly high level of riding comfort for the rider of the electric bicycle can be enabled.

Particularly preferably, the ramp area comprises at least two sub-areas with different slopes of the continuous increase of the target motor assistance. That is to say, the gradient of the characteristic curve is different in the at least two sub-areas of the ramp area. Preferably, the gradient in a first sub-area, which is at lower engagement ratios, is less than the gradient in a second sub-area, which is at higher engagement ratios. The characteristic curve in the two sub-areas is particularly preferably configured as a straight line. Alternatively preferably, the characteristic curve may be configured in the form of any mathematical function. Thus, it may be possible for a slow increase in motor torque to occur within the ramp area at lower engagement ratios, wherein a faster increase in motor torque occurs at higher engagement ratios close to the active rider engagement. In particular, this can prevent or reduce so-called coasting, where the rider pedals at a low pedaling frequency and without engagement, while at the same time generating a comparatively high motor torque. In addition, reliable and fast activation of motor assistance can be provided just before rider engagement.

Preferably, the method further comprises the following step: scaling the characteristic curve as a function of various, preferably manually actuatable, assistance modes of the electric bicycle. Scaling is particularly considered to be altering the characteristic curve with respect to varying amounts of motor assistance. For example, the characteristic curve may be shifted in the axis of motor assistance for different support modes. Alternatively or additionally, the areas may preferably be displaced, stretched, or compressed with respect to different engagement ratios. Thus, in particular, the degree of assistance by the drive unit can be configured differently in the various assistance modes.

Preferably, the transmission ratio is determined based on a signal from a shift system. In particular, if the shift system comprises an electronic gearshift, the transmission ratio may be provided, for example, directly as a signal from the gearshift system. Alternatively or additionally, the transmission ratio is preferably determined based on the detected pedaling frequency of the crank mechanism and the detected rear wheel speed of the rear wheel, preferably when active rider engagement has been detected. That is, the instantaneous transmission ratio can also be calculated in situations where active rider engagement is present. For example, the transmission ratio may be maintained after a calculation, and preferably subsequently recalculated in certain situations, such as during a gear change. Alternatively or additionally, preferably the transmission ratio may be automatically recalculated at regular intervals. Thus, the transmission ratio may be determined in a flexible and effective manner and the engagement ratio determined based thereon.

Preferably, detecting of the pedaling frequency of the crank mechanism occurs by way of a higher temporal scanning rate than detecting the rear wheel speed of the rear wheel. In other words, pedaling frequency sensors for detecting the pedaling frequency have a higher temporal scanning rate than rear wheel speed sensors for detecting the rear wheel speed. A particularly precise and reliable detection of the variables relevant for carrying out the method can thus be performed. In particular, the rider engagement can therefore be reliably detected. Furthermore, it can be used to precisely determine the increase in the pedaling frequency via the rear wheel speed, which results in engagement ratio greater than 1 and thus falls within the boost area.

Furthermore, the disclosure leads to a drive assembly for an electric cycle comprising a control unit configured to perform the described method. In particular, the drive assembly further comprises a drive unit, wherein the control unit is additionally configured to control the drive unit to generate the motor torque.

Furthermore, the disclosure relates to an electric bicycle comprising the described drive assembly.

Preferably, the electric bicycle or drive assembly is configured without a torque sensor and/or without a bearing force sensor. That is to say, in particular, there is no torque sensor and/or bearing force sensor to detect pedal actuation. By this, a particularly simple and cost-effective design of the electric bicycle or the drive assembly can be provided.

### BRIEF DESCRIPTION OF THE DRAWINGS

The disclosure is described hereinafter based on exemplary embodiment in connection with the figures. In the drawings, functionally identical components are respectively denoted by identical reference signs. Shown are:

FIG. 1 is a simplified schematic view of an electric bicycle in which a method according to a preferred embodiment example of the disclosure is carried out,

FIG. 2 is a highly simplified schematic view of the method according to the disclosure.

FIG. 3 is a highly simplified schematic view of an exemplary characteristic curve used in the method according to the disclosure.

### DETAILED DESCRIPTION

Preferably, all identical components, elements, and/or units are provided with the same reference symbols in all figures.

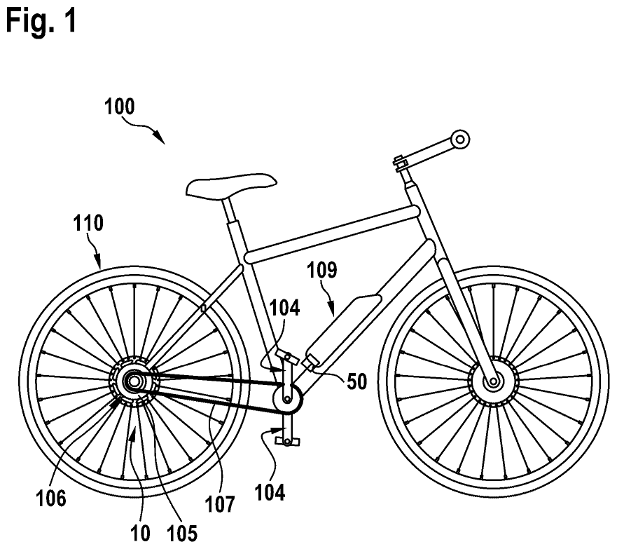

FIG. 1 shows a simplified schematic view of an electric bicycle 100 with a drive assembly 10 in which a method 20 for operating the drive assembly 10 according to a preferred exemplary embodiment of the disclosure is carried out.

The drive assembly 10 of the electric bicycle 100 comprises a drive unit 105 having a motor, in particular an electric motor. The motor can be supplied with electrical energy by way of an electrical energy storage unit 109 of the electric bicycle 100.

The drive unit 105 is configured as a hub drive unit and is arranged on a rear wheel hub of a rear wheel 110 of the electric bicycle 100.

In an alternative preferred embodiment (not shown), it may also be an electric bicycle 100 with a center motor, in which the drive unit 105 is arranged in the area of a bottom bracket.

A motor torque generated by the motor of the drive unit 105 can be used to provide motorized support for the pedal force generated by the muscle power of a rider of the electric bicycle 100. The muscle power of the rider can be applied via a crank mechanism 104 with crank levers.

The drive assembly 10 further comprises a control unit 50, which is configured to actuate the drive unit 105 in a controlled manner. For example, the control unit 50 may control an electrical actuation current to actuate the motor of the drive unit 105.

The control unit 50, in the illustrated embodiment, is arranged on the electrical energy store 109, by way of example. Alternatively, the control unit 50 may also be arranged at any other positions on the electric bicycle 100.

The pedal torque applied by the rider to the crank mechanism 104 may be transmitted to the rear hub of the rear wheel 110 via a transmission element 107, preferably a bicycle chain.

Preferably, a transmission is arranged between the motor of the drive unit 105 and the rear wheel hub, which is part of the drive unit 105.

Furthermore, the electric bicycle 100 includes a shift system 106 by way of which multiple different transmission ratios can be provided. For example, the shift system 105 may be manually actuatable by the rider and/or may be automatically actuatable by the control unit 50 to provide different transmission ratios.

Method 20 involves controlled actuation of the drive unit 105 as a function of the pedal actuation by the rider, without the use of pedal force or pedaling torque sensors.

The control unit 50 is configured to carry out the method 20.

In method 20, detecting 21 a pedaling frequency of the crank mechanism 104 occurs and detecting 22 a rear wheel speed of the rear wheel 110 occurs at the same time.

Furthermore, a determination 23 of the instantaneous transmission ratio between the crank mechanism 104 and the rear wheel 110 occurs simultaneously.

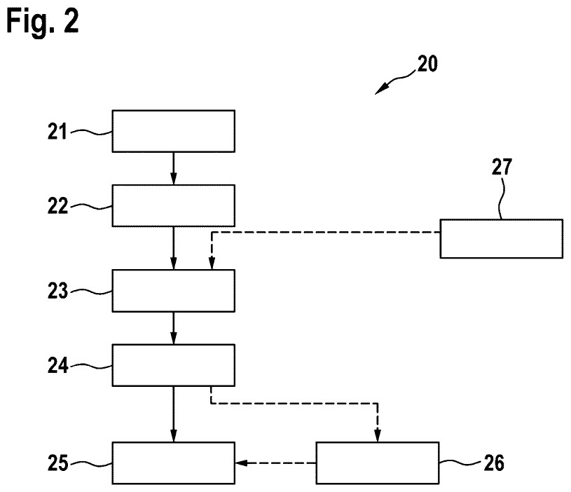

Preferably, determining 23 the transmission ratio is based on providing the instantaneous transmission ratio by way of a determination unit, which determines and provides the transmission ratio in step 27 of FIG. 2. Exemplary methods for determining the transmission ratio will be described later.

Based on the detected pedaling frequency and the detected rear wheel speed and the determined transmission ratio, a determination 24 of an engagement ratio 31 occurs.

Depending on the determined engagement ratio 31, the motor torque is subsequently generated 25 by way of the drive unit 105.

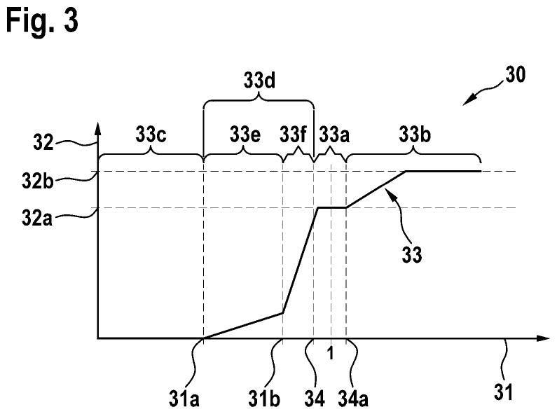

Preferably, the method optionally involves detecting 26 an active rider engagement if the engagement ratio 31 determined in step 24 corresponds to at least one predetermined engagement threshold value 34 (cf. FIG. 3). Preferably, in this case, the motor torque is generated 25 alternatively or additionally as a function of the active rider engagement detected in step 26.

In the method 20, the motor torque is generated 25 based on a characteristic curve 33, as explained below with the aid of FIG. 3.

FIG. 3 shows a simplified schematic view of a graph 30 depicting an exemplary characteristic curve 33.

The characteristic line 33 defines a target motor assistance 32 as a function of the engagement ratio 31.

Preferably, a predetermined factor is determined as the target motor assistance 32, which is multiplied by a drive controller torque, which in particular outputs drive controller of the electric bicycle 100. Preferably, the drive controller torque may correspond to a constant torque value, which in particular is lower than a maximum technical torque of the drive unit 105.

The characteristic curve 33 comprises four different areas 33a, 33b, 33c, 33d.

An engagement area 33a of the characteristic curve 33 extends from a predetermined engagement threshold value 34, which is preferably 0.95, to an upper engagement threshold value 34a, which is preferably 1.05. Within the engagement area 33a, the characteristic curve 33 defines a predetermined engagement motor assistance 32a as the target motor assistance 32.

For engagement area 33a, a factor 1 is preferably output as engagement motor assistance 32a.

Furthermore, the characteristic curve 33 defines a boost area 33b, which lies above the engagement area 33a for engagement ratios 31. Such excessive engagement ratios 31 may occur, for example, when the rider of the electric bicycle 100 pedals very hard, which can cause strain in the drive train, particularly in the transmission element, which may result in a higher pedaling frequency compared to the rear wheel speed when considering the transmission ratio.

In the boost area 33b, there is initially a linear increase of the target motor assistance 32 with the engagement ratio 31, up to a maximum value corresponding to a boost motor assistance 32b. Preferably, the boost motor assistance 32b corresponds to a maximum motor torque of the drive unit 105. This means that very strong pedaling by the rider can be interpreted as a request for maximum motor assistance, and a high motor torque can be generated accordingly.

Furthermore, the characteristic curve 33 defines a neutral area 33c which lies at the smallest engagement ratios, in particular from zero to a maximum neutral engagement ratio 31a of 0.5. The neutral area 33c defines a target motor assist 32 of zero. This means that in the neutral area 33c, it is assumed that the rider is not pedaling at all or is pedaling without resistance. In this area, no motor assistance is to be provided by the drive unit.

Furthermore, the characteristic curve 33 defines a ramp area 33d, which lies between the neutral area 33c and the engagement area 33a. Within the ramp area 33d, a continuous increase in the target motor assistance 32 is defined as a function of the determined engagement ratio 31 starting from zero, up to the predetermined engagement motor assistance 32a.

The ramp area 33d comprises a first sub-area 33e and a second sub-area 33f. The first sub-area 33e at lower engagement ratios 31 has a lower slope of the characteristic curve 33 than the second sub-area 33f.

In particular, the transition between first sub-area 33e and second sub-area 33f is at a ramp engagement ratio 31b, which is preferably 0.8.

The slope of the characteristic curve 33 is preferably less than 1 in the first sub-area 33e, and in particular greater than 1 in the second sub-area 33f.

The ramp area 33d ensures a continuous, smooth start-up of the motor assistance between the areas with no motor assistance and with full motor assistance. As such, a smooth engagement of the motor assistance may be provided, thereby providing a natural riding feeling and thus a particularly high level of riding comfort for the rider of the electric bicycle 100.

Determining 23 the transmission ratio when performing the method 20 may preferably be based on a signal from the shift system 106 of the electric bicycle 100, in particular if the shift system 106 has an electronic gearshift. In this case, for example, the shift system 106 may provide the instantaneous transmission ratio directly as a value, for example, based on previously known characteristics of the shift system 106 and the drive train of the electric bicycle 100.

Alternatively, the transmission ratio may be automatically calculated. Here, the transmission ratio may be based on the detected pedaling frequency of the crank mechanism 104 and the detected rear wheel speed of the rear wheel 110 during the detected active rider engagement.

For example, if no active rider engagement is detected, the transmission ratio may be assumed to be constant and recalculated, for example, at the next detected rider engagement.

For example, a predetermined example transmission ratio may be assumed prior to a first detection of the active rider engagement.

What is claimed is:

1. A method for operating a drive assembly of an electric bicycle, comprising:
detecting a pedaling frequency of a crank mechanism;
detecting a rear wheel speed of a rear wheel;
determining a transmission ratio between the crank mechanism and the rear wheel;
determining an engagement ratio based on pedaling frequency and rear wheel speed and transmission ratio; and
generating the motor torque as a function of the determined engagement ratio.

2. The method according to claim 1, further comprising detecting an active rider engagement when the determined engagement ratio corresponds to at least a predetermined engagement threshold value,
wherein generating the motor torque occurs as a function of the detected active rider engagement.

3. The method according to claim 1, wherein:
a characteristic curve is defined which defines a target motor assistance as a function of the engagement ratio, and
generating the motor torque is based on the characteristic curve.

4. The method according to claim 3, wherein:
the characteristic curve defines an engagement area within which an engagement ratio has a value of 1, and
the engagement area defines a predetermined engagement motor assistance as the target motor assistance.

5. The method according to claim 4, wherein:
the characteristic curve comprises a boost area which has an engagement ratio of greater than 1, and
the boost area defines a boost motor assistance as target motor assistance that is greater than the engagement motor assistance.

6. The method according to claim 4, wherein:
the characteristic curve defines a neutral area which is at engagement ratios of less than 0.8, and
the neutral area defines a target motor assistance of zero.

7. The method according to claim 6, wherein:
the characteristic curve defines a ramp area between the neutral area and the engagement area, and
the ramp area defines a continuous increase in the target motor assistance as a function of the determined engagement ratio.

8. The method according to claim 7, wherein the ramp area comprises at least two sub-areas with different slopes of the continuous increase in the target motor assistance.

9. The method according to claim 3, further comprising:
scaling the characteristic curve as a function of various assistance modes of the electric bicycle.

10. The method according to claim 1, wherein:
determining the transmission ratio is based on a signal of a shift system, and/or
determining the transmission ratio is based on the detected pedaling frequency of the crank mechanism and the detected rear wheel speed of the rear wheel.

11. The method according to claim 1, wherein detecting the pedaling frequency of the crank mechanism occurs by way of a temporal scanning rate higher than detecting the rear wheel speed of the rear wheel.

12. A drive assembly for an electric bicycle, comprising a control unit configured to perform the method according to claim 1.

13. An electric bicycle comprising a drive assembly according to claim 12.

14. The electric bicycle according to claim 13, wherein the electric bicycle or the drive assembly is configured without a torque sensor and/or without a bearing force sensor.

15. The method according to claim 4, wherein:
the characteristic curve comprises a boost area which has an engagement ratio of greater than or equal to 1.05, and
the boost area defines a boost motor assistance as target motor assistance that is greater than the engagement motor assistance.

16. The method according to claim 4, wherein:
the characteristic curve defines a neutral area which is at engagement ratios of less than 0.5, and
the neutral area defines a target motor assistance of zero.

17. The method according to claim 3, further comprising:
scaling the characteristic curve as a function of various, manually actuatable, assistance modes of the electric bicycle.

18. The method according to claim 1, wherein:
determining the transmission ratio is based on a signal of a shift system, and/or
determining the transmission ratio is based on the detected pedaling frequency of the crank mechanism and the detected rear wheel speed of the rear wheel when active rider engagement is detected.
